(19) United States
(12) Patent Application Publication
(10) Pub. No.: US 2006/0119562 A1
(43) Pub. Date: Jun. 8, 2006

(54) Liquid crystal driving circuit, liquid crystal display, and step-up frequency control method

(76) Inventor: Hiroyoshi Ichikura, Tokyo (JP)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/274,859

(22) Filed: Nov. 16, 2005

(30) Foreign Application Priority Data
Dec. 2, 2004 (JP) 2004-349446

(51) Int. Cl. G09G 3/36

(52) U.S. Cl. 345/98

(57) ABSTRACT

A liquid crystal driving circuit includes a step-up circuit that generates a voltage for driving a liquid crystal to display an image. A detection circuit processes the image data to detect information, such as the number of picture elements having a brightness level exceeding a reference level, or the number of displayable colors, from which the necessary liquid crystal driving current can be estimated. A step-up frequency control circuit controls the operating frequency of the step-up circuit according to the detected information. The step-up circuit can thereby be controlled to supply sufficient current without consuming unnecessary current itself.

### BACKGROUND OF THE INVENTION

1. Field of the Invention

The present invention relates to a liquid crystal display, a method of controlling the operating frequency of a step-up circuit, and in particular to a method of controlling the operating frequency of a step-up circuit used in a liquid crystal driving circuit to generate a liquid crystal driving voltage.

2. Description of the Related Art

Some liquid crystal driving circuits have a step-up circuit that operates at the frequency of an input clock signal to boost a system power supply voltage and uses the boosted voltage in driving a liquid crystal panel to display an image thereupon. In conventional liquid crystal driving circuits of this type, the input clock frequency (step-up frequency) is initially set to a value suitable for the liquid crystal panel, and is left fixed at this value throughout subsequent operation.

A problem with this scheme is that the amount of current consumed in driving the liquid crystal depends on the content of the image displayed. For a uniform display in which all picture elements (pixels) have the same brightness or gray level, for example, current consumption rises with increasing gray level as shown in FIG. 3. When a displayed image persistently requires more current than can be supplied at the fixed frequency setting, the boosted voltage droops and image quality suffers. Conversely, even when the displayed image requires less current than the fixed operating frequency makes available, the step-up circuit continues to operate at this frequency, in which case the step-up circuit itself consumes more current than necessary.

Japanese Patent Application Publication No. H10-214063 discloses a liquid crystal driving circuit that varies the step-up ratio of the step-up circuit (the factor by which the system power supply voltage is boosted), thereby varying the value of the boosted output voltage, in response to a command from a central processing unit. This scheme enables the output voltage to be varied according to the quantity of data to be displayed.

This scheme is useful for reducing power consumption when the image is displayed on only part of the liquid crystal panel. If only that part of the panel is scanned, the duty cycle of the scanning signals can be increased, so that a lower driving voltage suffices. This scheme fails, however, to take advantage of the opportunity to reduce current consumption when the entire liquid crystal panel is used to display an image with a relatively low gray level. Another disadvantage is that a step-up circuit capable of outputting different boosted voltages is necessarily more complex than a step-up circuit that outputs only a single boosted voltage. A further disadvantage is the need to program the central processing unit to generate the commands necessary to switch the boosted voltage, specify the scanned portion of the liquid crystal panel, and switch the duty cycle of the scanning signals.

### SUMMARY OF THE INVENTION

A general object of the present invention is to reduce the current consumption of a step-up circuit.

A more specific object is to reduce the current consumption of a step-up circuit in a driving circuit that drives a liquid crystal display, without impairing the quality of the displayed image.

The invention provides a method of controlling the operating frequency of a step-up circuit that boosts a power supply voltage and supplies current to a load circuit at the boosted voltage. The method includes detecting operating data of the load circuit from which the current drawn by the load circuit can be estimated, and setting the operating frequency of the step-up circuit according to the detected operating data.

The step-up circuit may be part of a liquid crystal driving circuit, and the load circuit may drive a liquid crystal panel to display an image. The step-up circuit then includes a detection circuit detects image content such as the number of colors displayed or the number of pixels exceeding a predetermined gray level, and a step-up frequency control circuit that controls the operating frequency of the step-up circuit according to the detected image content.

Reducing the operating frequency of the step-up circuit when the load circuit draws comparatively little current reduces the amount of current consumed by the step-up circuit. Reducing the operating frequency of the step-up circuit in a liquid crystal driving circuit according to the content of the displayed image enables current consumption to be reduced without loss of image quality.

### BRIEF DESCRIPTION OF THE DRAWINGS

In the attached drawings:

FIG. 1 is a block diagram of a liquid crystal display in a first embodiment of the invention;

FIG. 2 shows the internal structure of the frequency control circuit and detection circuit in the liquid crystal display in the first embodiment;

FIG. 3 is a graph illustrating the relationship between gray scale values of displayed data and current consumed by the liquid crystal panel displaying uniform data;

FIG. 4 is a graph illustrating output characteristics of a step-up circuit;

FIG. 5 is a graph illustrating the relationship between step-up frequency and current consumed by the step-up circuit; and

FIG. 6 shows the internal structure of the frequency control circuit and detection circuit in a liquid crystal display in a second embodiment of the invention.

### DETAILED DESCRIPTION OF THE INVENTION

Embodiments of the invention will now be described with reference to the attached drawings, in which like elements are indicated by like reference characters.

### FIRST EMBODIMENT

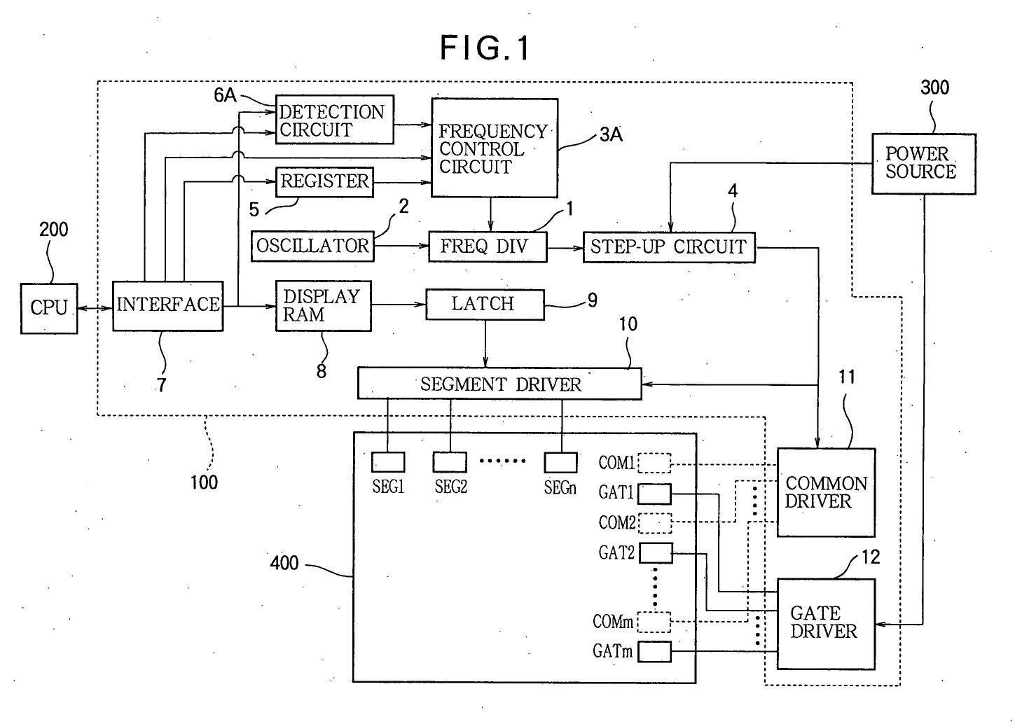

Referring to the block diagram in FIG. 1, the first embodiment of the invention is a liquid crystal display device comprising a liquid crystal driving circuit 100, a central processing unit (CPU) 200, a system power source 300, and a thin-film-transistor (TFT) liquid crystal panel 400.

The liquid crystal driving circuit 100 in this embodiment comprises a frequency divider (FREQ DIV) 1, an oscillator 2, a frequency control circuit 3A, a step-up circuit 4, a register 5, a detection circuit 6A, an interface 7, a display random-access memory (RAM) 8, a latch circuit 9, a segment driver 10, a common driver 11, and a gate driver 12.

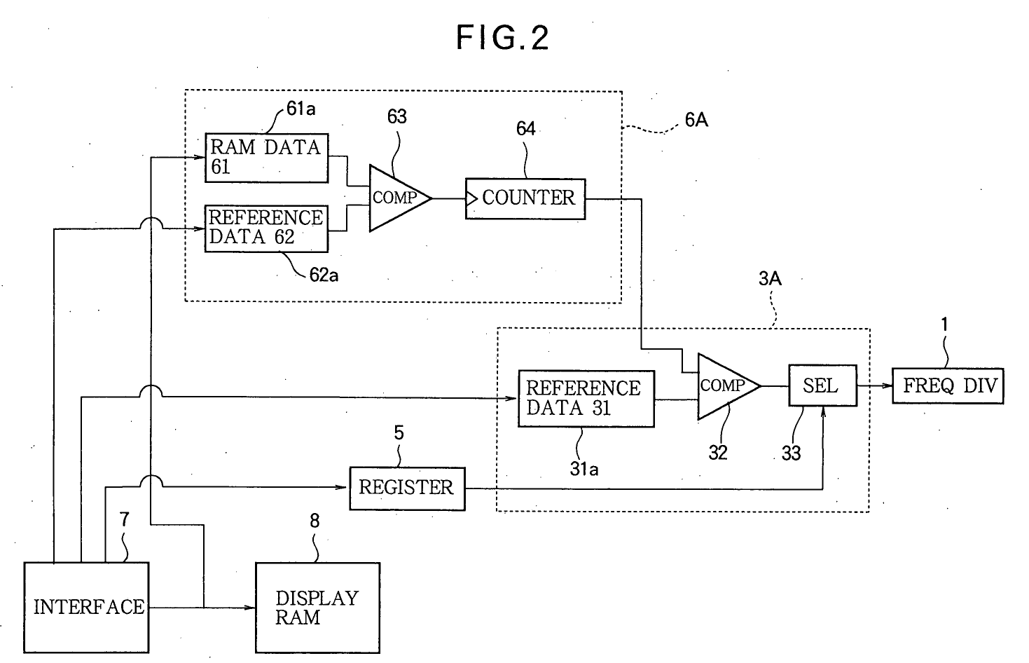

Referring to FIG. 2, the frequency control circuit 3A includes a register 31a for storing reference data 31, a comparator (COMP) 32, and a selector 33. The detection circuit 6A includes a register 61a for storing RAM data 61, a register 62a for storing reference data 62, a comparator 63, and a counter 64.

The frequency divider 1 divides the frequency of a clock signal input from the oscillator 2 by a frequency division ratio received from the frequency control circuit 3A, and outputs the divided clock signal to the step-up circuit 4.

The oscillator 2 generates the clock signal input to the frequency divider 1.

The step-up circuit 4 receives a system power supply voltage from the system power source 300, performs a voltage boosting operation at the frequency of the divided clock signal input from the frequency divider 1 (this operating frequency will be referred to as the step-up frequency), and supplies-current at the boosted voltage to the segment driver 10 and common driver 11, which constitute its load circuit. The current output capability of the step-up circuit 4 increases with the step-up frequency.

Register 5 stores reference (REF) data used by the frequency control circuit 3A to set the frequency division ratio in the frequency divider 1 to a default frequency division ratio. The reference data written in register 5 can be altered by a command from the CPU 200.

The interface 7 outputs image data sent from the CPU 200 to the display RAM 8 and outputs the gray scale values, (brightness or gray levels) of the image data to a register in the detection circuit 6A. The interface 7 also transfers reference data from the CPU 200 to register 5 and to registers in the frequency control circuit 3A and detection circuit 6A, and transfers various other data between the liquid crystal driving circuit 100 and the CPU 200.

The display RAM 8 stores image data received from the CPU 200 via the interface 7. The stored image data are read into the latch circuit 9.

The latch circuit 9 latches one or more lines of image data read from the display RAM 8, and outputs the latched image data to the segment driver 10 line-by-line in synchronization with the scanning timing of the TFT liquid crystal panel 400.

The segment driver 10 drives the segment terminals SEG1, SEG2, . . . , SEGn (n being a positive integer) of the TFT liquid crystal panel 400 in synchronization with the scanning timing by simultaneously applying n voltages obtained by dividing the boosted voltage supplied by the step-up circuit 4 according to a line (n pixels) of image data input from the latch circuit 9.

The common driver 11 drives the common terminals COM1, COM2, . . . , COMm (m being another positive integer) of the TFT liquid crystal panel 400 in synchronization with the scanning timing by applying the boosted voltage supplied by the step-up circuit 4.

The gate driver 12 switches the thin-film transistors in the TFT liquid crystal-panel 400 on and off in synchronization with the scanning timing of the TFT liquid crystal panel 400 by applying the system power supply voltage supplied from the system power source 300 to m gate terminals GAT1, GAT2, . . . , GATm, each of which is connected to the gate electrodes of the n thin-film transistors in one line. The m gate terminals are scanned (driven) cyclically, one complete cycle constituting one complete frame of the displayed image.

In the detection circuit 6A, shown in more detail the FIG. 2, RAM data 61 are written sequentially into register 61a and output to the comparator 63 as information that can be used to estimate the current that will be drawn by the segment driver 10 and common driver 11 to display the image described by the RAM data (this current is the output load current of the step-up circuit 4). In this example, the RAM data 61 comprise the actual gray scale values of the image data.

In a variation of the detection circuit 6A, register 61a is eliminated and the RAM data 61 are input directly from the interface 7 to the comparator 63.

Register 62a stores reference data 62 with which the gray scale values written in register 61a are compared. The reference data 62 in register 62a can be altered by a command from the CPU 200.

The comparator 63 compares the RAM data 61 in register 61a with the reference data 62 in register 62a and outputs the comparison result to the counter 64. Each comparison result indicates whether the current gray scale value exceeds the value of the reference data 62.

The counter 64 counts the number of times the RAM data 61 exceed the value of the reference data 62 during a predetermined interval such as a line interval or frame interval, and outputs the resulting count to the comparator 32 in the frequency control circuit 3A.

In the frequency control circuit 3A, shown in the FIG. 2, the comparator 32 compares the count received from the detection circuit 6A with the reference data 31 stored in register 31a, and outputs the result of this comparison to the selector 33. The reference data-31 written in register 31a can be altered by a command from the CPU 200.

The selector 33 selects the frequency division ratio used in the frequency divider 1. If the count received from the detection circuit 6A is equal to or less than the value of the reference data 31 stored in register 31a, as determined by the comparator 32, the selector 33 selects the default frequency division ratio set by the reference data held in register 5. If the count received from the detection circuit 6A exceeds the reference data 31, the selector 33 selects a lower frequency division ratio, producing a higher step-up frequency. The selector 33 sets the selected frequency division ratio in an internal register (not shown) and outputs the set frequency division ratio to the frequency divider 1.

The values set in registers 5, 31a, and 62a should be adjusted so that when the count output by the counter 64 is equal to or less than the value of the reference data 31 set in register 31a, the frequency divider 1 can provide adequate driving current by operating at the step-up frequency produced by the frequency division ratio set in register 5, and when the count output by the counter 64 exceeds the value of the reference data 31 in register 31a, a higher step-up frequency, corresponding to a lower frequency division ratio, is required.

Next, the operation of the liquid crystal driving circuit 100 in the first embodiment will be described.

In the selector 33 in the frequency control circuit 3A, when the output from the comparator 32 indicates that it is not necessary to change the default frequency division ratio, the default frequency division ratio set by the reference data from the register 5 is used. The clock signal supplied from the oscillator 2 is divided in the frequency divider 1 by the default frequency division ratio, and the divided clock signal, having the default step-up frequency set by the reference data, is supplied from the frequency divider 1 to the step-up circuit 4. Operating at the frequency of the divided clock signal, the step-up circuit 4 performs a voltage boosting operation and supplies current at the resulting boosted voltage to the segment driver 10 and common driver 11.

It will be assumed as an example below that the gray scale for the image data has sixty-four levels, ranging from ‘1’ to ‘64’, among which image data having gray scale value ‘64’ consume the most liquid crystal driving current, while image data having gray scale value ‘1’ consume the least liquid crystal driving current. For this example, the value of the reference data 62 for the gray scale in the detection circuit 6A may be set to ‘32’, which is substantially the mean value of the sixty-four levels.

In the liquid crystal driving circuit 100, the detection circuit 6A operates on each pixel level as it is received and outputs a new count value once per-line or once per frame. The frequency control circuit 3A operates according to the received count value for the duration of the line or frame.

In the detection circuit 6A, the comparator 63 compares the RAM data 61 written by the CPU 200 in the display RAM 8 as the value of one pixel on the sixty-four-level gray scale with the reference data 62 (‘32’, the mean level on the gray scale), to determine if the value of the RAM data 61 exceeds the value of the reference data 62. The counter 64 counts the number of times the value of the RAM data 61 exceeds the value of the reference data 62.

A RAM data value greater than the reference data value (‘32’) is indicative of a gray level that causes the segment driver 10 and common driver 11 to draw current at a rate in excess of the current driving capability of the step-up circuit 4 when operating at the default frequency setting. Comparator 63 outputs a binary ‘1’, for example, to the counter 64 to indicate that extra current will be drawn. A RAM data value equal to or less than the reference data value is indicative of a gray level within the current driving capability of the step-up circuit 4 at the default frequency setting. Comparator 63 outputs a binary ‘0’, for example, to the counter 64, to indicate that extra current will not be drawn.

The counter 64 counts the number of RAM data values that indicate a need for extra current by, for example, incrementing when the comparator 63 outputs a ‘1’ but not incrementing when the comparator 63 outputs a ‘0’. At the end of each line or, alternatively, at the end of each frame, the counter 64 outputs the total count for the line or frame to the comparator 32 in the frequency control circuit 3A.

For example, if the number of the pixels in one line of the TFT liquid crystal panel 400 is one hundred (n=100) and the counter 64 counts on a line-by-line basis, the reference data 31 in the frequency control circuit 3A may be set to one-half of the number of the pixels per line (i.e., ‘50’). In this case, the total output from the counter 64 to the comparator 32 is an integer from ‘0’ to ‘100’.

Alternatively, if the total number of pixels in the TFT liquid crystal panel 400 is ten thousand (m=100, n=100), and the counter 64 counts on a frame-by-frame basis, the reference data 31 in the frequency control . . . circuit 3A may be set to one-half of the number of the pixels per frame (i.e., ‘5000’).

Line-by-line counting will be assumed in the following description.

In the frequency control circuit 3A, comparator 32 decides whether the pixels in one line have predominantly high gray levels by deciding, in this example, whether the count output from the counter 64, representing the number of pixels in one line having gray levels equal to or greater than ‘33’, exceeds the value (‘50’) of the reference data 31, representing half of the number of pixels in the line). The selector 33 selects a frequency division ratio according to the comparison result.

When the total count output by the counter 64 exceeds the value of the reference data 31 (‘50’), the comparator 32 outputs a binary ‘1’ to the selector 33, indicating that the line under consideration will draw extra current. When the total count output by the counter 64 is equal to or less than the value of the reference data 31 (‘50’), the comparator 32 outputs a binary ‘0’ to the selector 33, indicating that this line will not draw extra current.

The selector 33 responds to the output of the comparator 32 as described above, by selecting the default value stored in register 5 when the comparator 32 outputs a binary ‘0’, selecting a value less than the default value when the comparator 32 outputs a binary ‘1’, and supplying the selected value to the frequency divider 1.

Thus when fifty or fewer pixels in the one hundred pixels in one line have gray levels of ‘33’ or higher, the comparator 32 outputs a ‘0’ to indicate that extra liquid crystal driving current is not required, and the selector 33 selects the default value stored in register 5 as the frequency division ratio for the frequency divider 1. When more than fifty pixels in the one hundred pixels in one line have gray levels of ‘33’ or higher, the comparator 32 outputs a ‘1’ to indicate that extra liquid crystal driving current is required, and the selector 33 selects a value lower than the default value stored in register 5 as the frequency division ratio for the frequency divider 1, thereby increasing the frequency at which the step-up circuit 4 operates and enabling the step-up circuit 4 to supply the requisite extra current.

If the default frequency division ratio is eight, for example, then when extra liquid crystal driving current is required, the comparator 32 may decrease the frequency division ratio to four, thereby doubling the operating frequency of the step-up circuit 4 to enable the step-up circuit 4 to supply the needed current. When extra current is not required to drive the liquid crystal, the comparator 32 leaves the frequency division ratio at the default value, so that the step-up circuit 4 operates at a comparatively low frequency to save power.

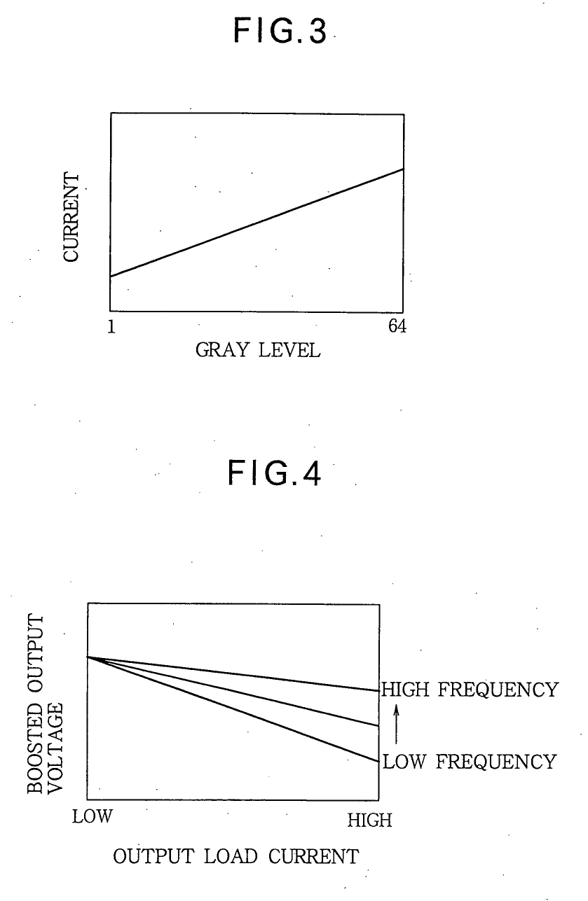

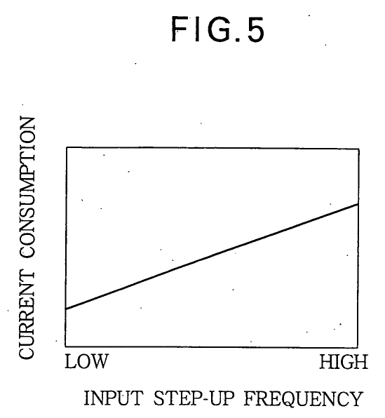

FIG. 3 showed that the amount of current needed to drive the liquid crystal increases with the gray level of the image displayed on the liquid crystal panel. FIG. 4 shows that the boosted voltage output by the step-up circuit 4 decreases with the amount of current drawn by the load (the liquid crystal panel), but that the rate of decrease depends on the operating frequency of the step-up circuit 4. FIG. 5 shows that as this operating frequency (the step-up frequency) increases, the amount of current consumed by the step-up circuit 4 also increases.

As can be seen from FIGS. 3 and 4, as the gray level of the displayed image increases, for a constant step-up frequency, the voltage output by the step-up circuit 4 decreases. If the boosted output voltage becomes too low, image quality is adversely affected. The voltage drop can be countered, however, by switching to a higher input step-up frequency to enhance the load driving capacity of the step-up circuit 4.

As can be seen from FIG. 5, however, operating the step-up circuit 4 at a higher step-up frequency increases the current consumed by the step-up circuit 4 itself. It is therefore desirable to operate the step-up circuit 4 at a comparatively low step-up frequency, as long as this does not impair the quality of the displayed image.

In the first embodiment, as described above, the step-up frequency is switched between a comparatively low default frequency and a higher frequency according to the number of pixels per line (or per frame) exceeding a predetermined reference gray level. This number provides an estimate of the necessary liquid crystal driving current, derived from the content of the display. An advantage of using this particular estimate of the necessary liquid crystal driving current is that the estimate can be derived by simple digital comparison operations and, unlike an analog estimate is not affected by manufacturing variations among circuit elements.

Another advantage of the first embodiment is that the step-up ratio and hence the nominal boosted output voltage does not change. Accordingly, the step-up circuit can have a relatively simple circuit configuration, designed for output of only a single boosted voltage, and the CPU 200 does not have to generate voltage-switching commands. In a liquid crystal driving circuit of the type that switches the step-up ratio of the step-up circuit, the complexity of the step-up circuit tends to make the boosted output voltages less accurate, and the processing load on the CPU is increased by the need not only to switch the output voltage of the step-up circuit but also to control the common driver and gate driver to switch the scanning signals and their duty cycles.

Switching the operating frequency of the step-up circuit 4 as in the first embodiment does not require complex circuitry; it is only necessary to switch the frequency division ratio supplied to the frequency divider 1. This switching is moreover performed by the frequency control circuit 3A on the basis of information supplied by the detection circuit 6A, without increasing the processing load on the CPU 200.

As described above, by switching the step-up frequency, the first embodiment reduces current consumption without impairing image quality. The additional requirements are a comparator 63 for comparing the image data written in the display RAM 8 with a reference value, a counter 64 for counting the number of pixels having image data that exceed the reference value, a comparator 32 for comparing the total number of such pixels per line or per frame with another reference value, and a selector 33 for selecting one of two step-up frequencies according to the result of this comparison. Comparators, counters, and selectors are relatively simple digital components; the addition of two comparators, one counter, and one selector does not greatly increase the complexity of the liquid crystal driving circuit 100.

In a variation of the first embodiment, the frequency control circuit 3A employs two reference values, such as, for example ‘50’ and ‘25’, if the counter 64 counts line-by-line. The comparator 32 compares the count output by the counter 64 with both reference values, and outputs a two-bit comparison result to the selector 33. If the count output by the counter 64 is greater than the lower reference value (‘25’) but equal to or less than the higher reference value (‘50’), the comparator 32 outputs, for example, a result of ‘0’ and the selector 33 selects the default frequency division ratio indicated in register 5. If the count output by the counter 64 is greater than the higher reference value (‘50’), the comparator 32 outputs, for example, a result of ‘1’ and the selector 33 selects a frequency division ratio lower than the default frequency division ratio, thereby increasing the step-up frequency. If the count output by the counter 64 is equal to or less than the lower reference value (‘25’), the comparator 32 outputs, for example, a result of ‘−1’ and the selector 33 selects a frequency division ratio higher than the default frequency division ratio, thereby reducing the step-up frequency. By reducing the step-up frequency of the step-up circuit 4 when the count is equal to or less than the lower reference value, this variation achieves a further reduction in current consumption.

In the first embodiment as described above, the liquid crystal image content from which the necessary liquid crystal driving current is estimated is the number of pixels per line (or per frame) having gray levels exceeding a reference level. In another variation, the total of the gray levels of the pixels in one line or frame is employed. In particular, if the TFT liquid crystal panel 400 is not a gray-scale panel but simply provides a bi-level display in which each pixel is either on or off, the total of the gray levels of the pixels is the number of pixels that are on. The reference data 62 and comparator 63 in the detection circuit 6A can then be eliminated.

Alternatively, if the TFT liquid crystal panel 400 is used to display images of various sizes, the liquid crystal image content from which the necessary liquid crystal driving current is estimable may be the number of pixels in the image currently being displayed, regardless of the gray levels or on-off status of the pixels. In this case the detection circuit 6A need only comprise a register in which the number of the pixels is written, instead of registers 61a and 62a, a comparator 63, and a counter 64. A corresponding reference value is written in register 31a in the frequency control circuit 3A. The selector 33 selects a comparatively low frequency division ratio, thereby operating the step-up circuit 4 at a comparatively high frequency, when the number of the pixels in the displayed image exceeds the reference value stored in register 31a.

### SECOND EMBODIMENT

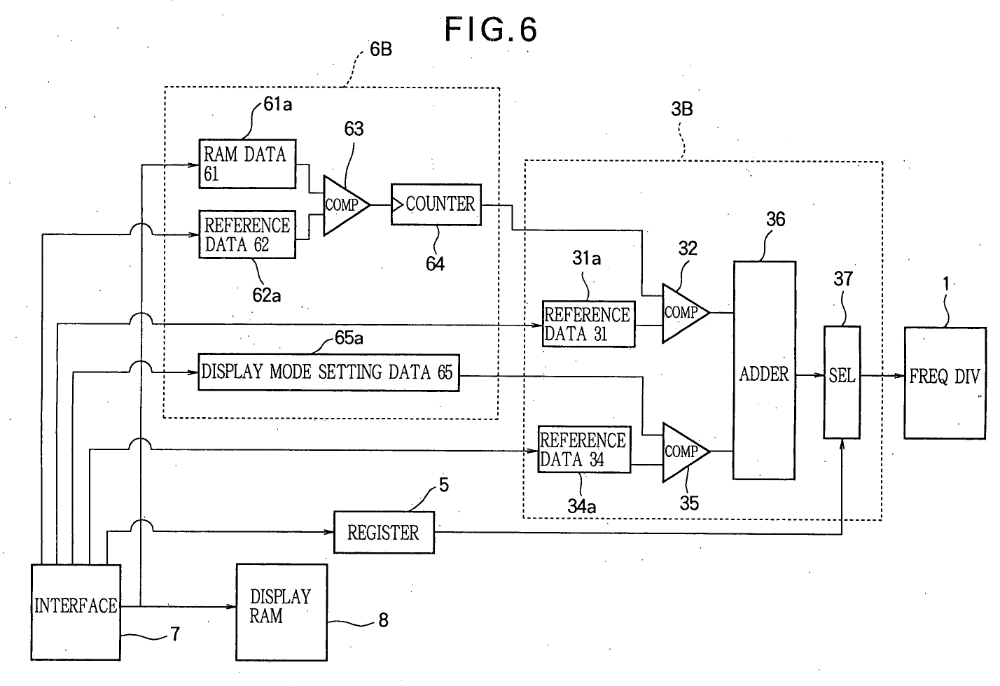

The second embodiment is a liquid display device similar to the first embodiment and has the general structure shown in FIG. 1, but the frequency control circuit 3A and detection circuit 6A shown in FIG. 2 are replaced by the frequency control circuit 3B and detection circuit 6B shown in FIG. 6.

The frequency control circuit 3B in the second embodiment comprises a register 31a for storing reference data 31 and a comparator 32 as in the first embodiment, another register 34a for storing reference data 34, another comparator 35, an algebraic adder 36, and a selector 37 that replaces the selector 33 in the first embodiment.

The detection circuit 6B in the second embodiment comprises a register 61a for storing RAM data 61, a register 62a for storing reference data 62, a comparator 63, and a counter 64 as in the first embodiment, and a register 65a for storing display mode setting data 65. The display mode setting data 65 give information such as the number of displayable colors, the polarity inversion period, the polarity inversion mode, and the frame rate. This information is written in register 65a by the CPU 200, via the interface 7, and is output to the comparator 35 in the frequency control circuit 3B for use in estimating the liquid crystal driving current. In the following description, the display mode setting data 65 give the number of displayable colors.

A reference number of colors is written as reference data 34 in register 34a in the frequency control circuit 3B, and is also output to the comparator 35. The reference data 34 written in register 34a can be altered in response to a command from the CPU 200.

Comparator 35 compares the display mode setting data 65 input from the detection circuit 6B with the reference data 34, and outputs the result to the algebraic adder 36. In the second embodiment, the comparison results from both comparators 32 and comparator 35 are output to the algebraic adder 36. The algebraic adder 36 adds or subtracts the comparison results input from the comparators 32 and 35, and outputs the resulting sum or difference to the selector 37.

Depending on the sum or difference output by the algebraic adder 36, the selector 37 selects the default frequency division ratio specified by the reference data stored in the register 5, or selects a different frequency division ratio. The selected frequency division ratio is set in an internal register (not visible) in the selector 37 and output to the frequency divider 1.

Next, the operation of the liquid crystal driving circuit of the second embodiment will be described. Descriptions of the operation of the comparator 63 and counter 64 in the detection circuit 6B, and of comparator 32 in the frequency control circuit 3B, will be omitted because these elements operate as described in the first embodiment. The counter 64 may count on a line-by-line basis or a frame-by-frame basis: line-by-line counting will be assumed below.

When the output from the algebraic adder 36 indicates that no change in the frequency division ratio is necessary, the selector 37 in the frequency control circuit 3B selects the default frequency division ratio specified by the reference data in the register 5, and the clock signal supplied from the oscillator 2 is divided by the default frequency division ratio in the frequency divider 1. The divided clock signal is supplied from the frequency divider 1 to the step-up circuit 4, which operates at the default step-up frequency, and supplies the resultant boosted voltage to the segment driver 10 and the common driver 11.

The number of displayable colors may be, for example, approximately two hundred sixty thousand (260,000, represented by 64 gray levels in each of three primary colors), approximately sixty-five thousand (65,000, represented by sixteen bits of image data per pixel) or just eight. Of these three modes, the mode with approximately 260,000 colors, referred to below as the two-hundred-sixty-thousand-color mode, consumes the most liquid crystal driving current, while the eight-color mode consumes the least liquid crystal driving current.

If the setting that represents the two-hundred-sixty-thousand-color mode is ‘2’, the setting that represents the sixty-five-thousand-color mode is ‘1’, and the setting that represents the eight color mode is ‘0’, then the value ‘2’, ‘1’ or ‘0’ is included in the display mode setting data 65 written in register 65a to indicate the number of displayable colors. One of these values is also set as reference data 34 in the frequency control circuit 3B. In the following description, it will be assumed that the number ‘2’, indicating the two-hundred-sixty-thousand-color mode, is set as the reference data value. The reference data value is normally set as part of an initialization routine when the CPU 200 begins operation or is reset. The display mode setting data 65 may also be set by this routine, but may be altered according to different types of image content.

In the liquid crystal driving circuit of the second embodiment, as the CPU 200 sends new image data through the interface 7 to the display RAM 8, the detection circuit 6B and the frequency control circuit 3B operate as described in the first embodiment. When the new image data are stored in the display RAM 8, the same data values are written as RAM data 61 in register 61a in the detection circuit 6B, overwriting the existing contents of register 61a and updating the output from the comparator 32 in the frequency control circuit 3B. When the display mode setting is changed, the display mode setting data 65 in the detection circuit 6B are overwritten, updating the output from the comparator 35 in the frequency control circuit 3B.

In the frequency control circuit 3B, comparator 32 compares the total count output by the counter 64, indicating the number of times the value of the RAM data 61 exceeds the value of reference data 62 in one line, with reference data 31. If the total count exceeds reference data 31, comparator 32 outputs a signal representing the value ‘1’ to the algebraic adder 36, indicating that extra liquid crystal driving current may be necessary. If the total count is equal to or less than reference data 31, the comparator 32 outputs a signal representing the value ‘0’ to the algebraic adder 36, indicating that extra liquid crystal driving current is not necessary.

Comparator 35 compares the display mode setting data 65, which indicates the number of displayable colors in the display mode setting sent from the CPU (FIG. 1) through the interface 7, with reference data 34 which, in the present example, are ‘2’, indicating the two-hundred-sixty-thousand-color setting. The display mode setting data 65 may be ‘2’ (260 thousand colors), ‘1’ (65 thousand colors), or ‘0’ (eight colors) as noted above.

When the value of the display mode setting data 65 is less than the value of reference data 34 (=‘2’), comparator 35 outputs a signal representing the value ‘−1’, for example, to the algebraic adder 36, indicating that the liquid crystal driving current supply can be reduced. When the display mode setting data 65 is equal to or greater than reference data 34 (=‘2’), the comparator 35 outputs a signal representing the value ‘0’ to the algebraic adder 36, indicating that the liquid crystal driving current supply cannot be reduced.

The algebraic adder 36 adds or subtracts the bi-valued signals output from the comparators 32 and 35 to calculate the sum (‘0’, ‘1’ or ‘−1’) of the values represented by the outputs from comparator 32 (‘0’ or ‘1’) and comparator 35 (‘0’ or ‘−1’). The sum is represented as a binary number and output to the selector 37.

Various addition or subtraction schemes are possible. For example, if comparators 32 and 35 output signals with ‘0’ and ‘1’ logic levels, but in the output of comparator 32 the ‘0’ logic level represents the value ‘0’ and the ‘1’ logic level represents the value ‘1’ while in the output of comparator 35 the ‘0’ logic level represents the value ‘0’ and the ‘1’ logic level represents the value ‘−1’, the algebraic adder 36, which treats the logic levels as binary numbers, may subtract the ‘0’ or ‘1’ output of comparator 35 from the ‘0’ or ‘1’ output of comparator 32 to obtain the value ‘0’, ‘1’, or ‘−1’.

Alternatively, if the ‘0’ logic level represents the value ‘−1’ and the ‘1’ logic level represents the value ‘0’ in the output of comparator 35, the algebraic adder 36 may add the outputs of comparators 32 and 35 to obtain a sum of ‘1’, or ‘2’, then subtract ‘1’ to obtain the value ‘0’, ‘1’, or ‘−1’.

On the basis of the result received from the algebraic adder 36, the selector 37 selects the default division ratio or a different division ratio, thereby controlling the step-up frequency at which the frequency divider 1 operates. The default division ratio is selected when the received sum value is ‘0’. A lower division ratio (higher step-up frequency) is selected when the received result is ‘1’. A higher division ratio (lower step-up frequency) is selected when the received result is ‘−1’.

Accordingly, the selector 37 selects the default frequency division ratio when the number of displayable colors is set to two hundred sixty thousand but fifty or fewer of the one hundred pixels in the current line have gray levels of ‘33’ or more, or when the number of display colors is set to sixty-five thousand or eight and more than fifty of the one hundred pixels in the current line have gray scale levels of ‘33’ or more.

When the number of colors is set to two hundred sixty thousand and more than fifty of the one hundred pixels in the current line have gray levels of ‘33’ or more, the selector 37 selects a frequency division ratio lower than the default ratio to increase the step-up frequency so that the step-up circuit 4 can provide the additional current needed under these conditions.

When the number of colors is set to sixty-five thousand or eight and fifty or fewer of the one hundred pixels in the current line have gray levels of ‘33’ or more the selector 37 selects a frequency division ratio higher than the default ratio to decrease the step-up frequency and reduce the amount of current consumed by the step-up circuit 4. The current output capability of the step-up circuit 4 is reduced accordingly, but the reduced output is sufficient under these display conditions.

If, for example, the default frequency division ratio is eight, then upon receiving the value ‘1’ from the algebraic adder 36, indicating that additional liquid crystal driving current is required, the selector 37 may select a frequency division ratio of four, thereby doubling the step-up frequency to enhance the driving capability of the step-up circuit 4. When the selector 37 receives the value ‘−1’ from the algebraic adder 36, it selects a frequency division ratio of sixteen, thereby halving the step-up frequency to reduce the driving capability and current consumption of the step-up circuit 4. When the selector 37 receives the value ‘0’ from the algebraic adder 36, it selects the default frequency division ratio of eight.

As described above, the second embodiment can take advantage of the combination of a reduced number of colors and a predominance of pixels with low gray levels, which greatly reduces the amount of current required by the TFT liquid crystal panel 400, to save power by reducing the step-up frequency to a lower value than the default value, which was the minimum value in the first embodiment, without loss of displayed image quality. The second embodiment thus adjusts the supply of liquid crystal driving current to match the required amount of current more accurately than the first embodiment, by using more information about the displayed image content so that it can estimate the current requirement more accurately. This advantage is achieved by providing the frequency control circuit 3B with two comparators 32, 35 instead of one, so that the frequency control circuit 3B can detect conditions requiring both more and less current than can be supplied at the default frequency division ratio. The only other additional hardware necessary is the pair of registers 65a, 34a that store display mode setting information and corresponding reference data 34, the algebraic adder 36 that performs an arithmetic operation on the outputs of the comparators 32, 35, and additional hardware in the selector 37 to enable selection of ratios both higher and lower than the default frequency division ratio.

Like the first embodiment, the second embodiment can be modified to compare the output of the counter 64 with more than one reference value, e.g., with reference values equal to one half and one quarter of the number of pixels in one line or frame (reference values of ‘50’ and ‘25’ if the counting is performed on a line-by-line basis there are one hundred pixels per line). The reference data 34 stored in register 34a can also be set to ‘1’ (65 thousand colors) instead of ‘2’ (260 thousand colors). In this case, both comparators 32 and 35 generate two-bit output.

For these reference values, comparator 32 compares the count output by the counter 64 with both ‘50’ and ‘25’. If the count is greater than ‘50’, comparator 32 outputs, for example, a binary number representing the value ‘1’, indicating that an increased amount of liquid crystal driving current is needed for the current line. If the count is greater than ‘25’ and equal to or less than ‘50’, the comparator 32 outputs a binary number representing ‘0’, indicating that the normal amount of current will suffice. If the count is equal to or less than ‘25’, the comparator 32 outputs a binary number representing ‘−1’, indicating that a reduced amount of liquid crystal driving current will suffice.

Similarly, if the display mode setting data 65 is less than reference data 34 (‘1’), indicating an eight-color display, comparator 35 outputs a binary number representing ‘−1’, indicating a reduced current requirement. If the display mode setting data 65 is equal to reference data 34, indicating a sixty-five-thousand-color display, comparator 35 outputs a binary number representing ‘0’, indicating the normal current requirement. If the color number is greater than reference data 34, indicating a two-hundred-sixty-thousand-color display, comparator 35 outputs a binary number representing ‘1’, indicating an increased current requirement.

The algebraic adder 36 adds the values represented by the outputs of the comparators 32, 35 and outputs data representing ‘−2’, ‘−1’, ‘0’, ‘1’ or ‘2’ to the selector 37.

The selector 37 now adjusts the frequency division ratio in five steps. If the data value output from the algebraic adder 36 is ‘1’ or ‘2’, the selector 37 reduces the frequency division ratio to enhance the driving capacity of the step-up circuit 4 by raising the frequency division ratio of the frequency divider 1 from the default setting by one step (when the data output from the algebraic adder 36 is ‘1’) or by two steps (when the data output from the algebraic adder 36 is ‘2’). If the data value output from the algebraic adder 36 is ‘−1’ or ‘−2’, the selector 37 increases the frequency division ratio to reduce the driving capacity of the step-up circuit 4 by lowering the frequency division ratio of the frequency divider 1 from the default setting by one step (when the data output from the algebraic adder 36 is ‘−1’) or by two steps (when the data output from the algebraic adder 36 is ‘−2’). If the data output from the algebraic adder 36 is ‘0’, the selector 37 assumes that the default amount of liquid crystal driving current is needed and leaves the default setting unchanged.

By adjusting the step-up frequency in five steps instead of three, this variation of the second embodiment further improves the accuracy with which the required liquid crystal driving current is estimated, and can save additional power without loss of image quality.

In another variation of the second embodiment, register 61a, register 62a, comparator 63, and counter 64 are omitted in the detection circuit 6B, register 31a, comparator 32, and algebraic adder 36 are omitted in the frequency control circuit 3B, and the selector 37 in the frequency control circuit 3B sets the step-up frequency based on the data output from comparator 35 alone (i.e., based on the display mode setting data 65 alone). For example, the selector 37 may select a default frequency division ratio for a sixty-five-thousand-color display, a lower frequency division ratio for a two-hundred-sixty-thousand-color display, and a higher frequency division ratio for an eight-color display.

The reference data 31, 34, and 62 used in the above embodiments need not be constant. A table of different liquid crystal driving current requirements that may arise due to manufacturing tolerances or differences in liquid crystal panel designs may be stored in the liquid display device, and the values of reference data 31, reference data 34, and reference data 62 may be factory-set for each device, to compensate for variations caused by manufacturing tolerances or differences in liquid crystal panels.

In the above embodiments, the data used for estimating the liquid crystal driving current comprised the gray levels of the pixels in one line or frame and a display mode setting, but other data can be used as well. For example, the step-up frequency may be altered according to an operating mode setting other than a display mode setting, with corresponding changes in the reference data.

Those skilled in the art will recognize that further variations are possible within the scope of the invention, which is defined in the appended claims.

What is claimed is:

1. A liquid crystal driving circuit including a step-up circuit that generates a voltage for driving a liquid crystal to display an image, comprising:
a detection circuit for detecting image content from which necessary liquid crystal driving current is estimable; and
a step-up frequency control circuit for controlling an operating frequency of the step-up circuit according to the detected image content.

2. The liquid crystal driving circuit of claim 1, wherein the image comprises a plurality of successively scanned lines, and the image content is detected once per line.

3. The liquid crystal driving circuit of claim 1, wherein the image comprises a plurality of temporally successive frames, and the image content is detected once per frame.

4. The liquid crystal driving circuit of claim 1, wherein the detected image content includes brightness of picture elements.

5. The liquid crystal driving circuit of claim 1, wherein the detected image content includes number of displayable colors.

6. The liquid crystal driving circuit of claim 1, wherein the detection circuit counts image data satisfying a predetermined condition.

7. The liquid crystal driving circuit of claim 6, wherein the detection circuit compares the image data with a predetermined reference value to decide whether the predetermined condition is satisfied.

8. The liquid crystal driving circuit of claim 6, wherein:
the detection circuit includes
a first register storing a quantity, derived from the image data, from which the necessary liquid crystal driving current is estimable;
a second register storing a reference value for said quantity;
a first comparator comparing the quantity stored in the first register with the reference value stored in the second register to decide whether the predetermined condition is satisfied; and
a counter for counting outputs of the first comparator satisfying the predetermined condition; and
the step-up frequency control circuit includes a third register storing a reference value for the count obtained by the counter;
a second comparator comparing the count obtained by the counter with the reference value stored in the third register; and
a selector selecting a frequency division ratio for a divided clock signal that drives the step-up circuit, the frequency division ratio being selected according to the output of the second comparator.

9. The liquid crystal driving circuit of claim 6, wherein the detection circuit also detects a display mode setting.

10. The liquid crystal driving circuit of claim 9, wherein:
the detection circuit includes
a first register storing a quantity from which the necessary liquid crystal driving current is estimable;
a second register storing a reference value of said quantity;
a first comparator comparing the quantity stored in the first register with the reference value stored in the second register to decide whether the predetermined condition is satisfied; and
a counter for counting outputs of the first comparator satisfying the predetermined condition; and
a third register storing the display mode setting; and
the step-up frequency control circuit includes a fourth register storing a reference value for the count obtained by the counter;
a second comparator comparing the count obtained by the counter with the reference value stored in the fourth register;
a fifth register storing a reference value of the display mode setting;
a third comparator comparing the display mode setting stored in the third register with the reference value stored in the fifth register;
an algebraic adder for algebraically adding outputs of the second comparator and the third comparator; and
a selector selecting a frequency division ratio for a divided clock signal that drives the step-up circuit, the frequency division ratio being selected according to an output of the algebraic adder.

11. A liquid crystal display device including the liquid crystal driving circuit of claim 1, comprising:
a liquid crystal panel driven by said liquid crystal display driving circuit; and
a processing unit for transferring the image data to the liquid crystal driving circuit.

12. A method of controlling the operating frequency of a step-up circuit that boosts a power supply voltage and supplies current to a load circuit at the boosted voltage, comprising:
detecting operating data of the load circuit, the operating data being data from which current drawn by the load circuit is estimable; and
setting the operating frequency of the step-up circuit according to the detected operating data.

13. The method of claim 12, wherein the load circuit drives a liquid crystal panel to display an image.

14. The method of claim 13, wherein detecting the operating data includes counting image data satisfying a predetermined condition.

15. The method of claim 13, wherein detecting the operating data includes comparing image data with at least one predetermined reference value.

16. The method of claim 13, wherein detecting the operating data includes determining a number of displayable colors.

17. The method of claim 13, wherein detecting the operating data includes determining a polarity inversion period.

18. The method of claim 13, wherein detecting the operating data includes determining a polarity inversion mode.

19. The method of claim 13, wherein detecting the operating data includes determining a frame rate.
